(19) United States
(12) Patent Application Publication
(10) Pub. No.: US 2005/0282633 A1
(43) Pub. Date: Dec. 22, 2005

(54) Movement-sensing apparatus for software

(76) Inventors: Frederic Nicolas, Moret-Sur-Loing (FR); Fabien Hermand, Paris (FR); Jean Bonnard, Paris (FR)

Correspondence Address: JACOBSON HOLMAN PLLC, 400 SEVENTH STREET N.W., SUITE 600, WASHINGTON, DC, 20004, US

(21) Appl. No.: 11/127,309

(22) Filed: May 12, 2005

Related U.S. Application Data
(63) Continuation-in-part of application No. 09/856,164, filed on Nov. 13, 2001, now Pat. No. 6,909,420.

(51) Int. Cl. A63F 13/00

(52) U.S. Cl. 463/36

(57) ABSTRACT

The invention aims at providing a video game input device for use with a standard video game equipment capable of displaying varying representations of a human body, said device comprising an apparatus for transforming movements of a user into sense signals and a processing unit for converting the sense signals into standard control signals for said standard video game equipment, said processing unit comprising an adjusting unit allowing the user to configure the conversion of said sense signals into said control signals. The input device preferably comprises a wireless communication module. Further, the apparatus comprises ergonomics and efficient elbow and leg sensors.

This application is a continuation-in-part of U.S. application Ser. No. 09/856,164, filed in Dec. 2, 1999.

Application Ser. No. 09/856,164 is incorporated herein by reference.

The present invention relates to software control means constituting sensors for sensing the movement of a part of a user's body.

Such control means conventionally include elements which reproduce a control or guide element (a joystick, a steering wheel, control pedals) and elements which are fixed to the body of a user (e.g. the arms or the hands) and that are designed to sense movements while impeding them as little as possible.

Thus, document U.S. Pat. No. 5,229,756 proposes a boxing fight simulator in which the user is fitted with elbow-bend sensors each fixed on a sleeve to measure the bend angle of an elbow and deliver an analog signal representative of said angle, which analog signal is subsequently converted into a digital signal for storing and processing.

That type of apparatus suffers from a major drawback.

The signal delivered by the sensor must be processed by a converter and by a computer, both requiring large computation and memory capacity.

In practice, that type of apparatus is used only with hardware and software specially designed for such an application because of the high requirements inherent to such sensors.

An object of the invention is to propose an apparatus which is suitable for transforming the position or displacement of a user's limb into a sense signal which is significantly representative of said position or displacement, while requiring little by way of computation and memory capacity.

Another object of the invention is to propose an arrangement of the apparatus, in particular of its sensors, enabling as much freedom of movement as possible.

Another object of the invention is to propose such a video game input device adaptable to any kind of standard video game, and where, in particular, the user can configure such adaptation.

Still another object of the invention is to propose such an apparatus having compact sensors, reliable in term of effectiveness, ergonomics and not expensive to make.

To that effect, the invention proposes a video game input device for use with a standard video game equipment capable of displaying varying representations of a human body, said device comprising an apparatus for transforming movements of a user into sense signals and a processing unit for converting the sense signals into standard control signals for said standard video game equipment, said processing unit comprising an adjusting unit allowing the user to configure the conversion of said sense signals into said control signals.

Preferred aspects this video game input device are the following:
the adjusting unit comprises manual actuators which the user can move according to predefined positions, each position corresponding to a predefined conversion of a sense signal into a control signal,
each actuator has, at the maximum, as many predefined positions as the number of possible control signals for said video game equipment,
said processing unit is connectable by a cable to a standard gamepad connector of a video game equipment,
said cable comprises a power line through which said processing unit can draw power from said video game equipment.

The invention further proposes a video game input device for use with a standard video game equipment capable of displaying varying representations of a human body, said device comprising a first part to be worn by a user for transforming movements of a user into sense signals, and a second part having a processing unit for outputting to said video game equipment standard control signals generated from said sense signals, and a wireless communications channel between said first part and said second part.

Preferred aspects this video game input device are the following:
said first part is powered by at least one battery,
the device further comprises an additional first part for being worn by another user, said additional first part being in communication with a second part through a distinct wireless communications channel,
the wireless communications channel is selected among available predefined communication channels, thus enabling in particular a multi user game,
the first and second parts of the device comprise a wireless communication module using a wireless communication channel selected among the predefined available communication channels, this selection being set by the user which can move an actuator in the first part and the second part, according to different positions corresponding to the available predefined communication channels.
said first part comprises:
   a pair of elbow sensors adapted to be positioned in respective elbow regions of the user to deliver two different sense signals depending on elbow bend, and
   a pair of knee sensors adapted to be positioned in respective knee regions of the user to deliver two different sense signals depending on knee bend,
said first part further comprises a pair of handles connected by respective wires to the pair of elbow sensors, each handle comprising at least one button capable of generating a further sense signal,
said wireless communication's channel is established between a transmitter in one of said handles and said second part,
said first part further comprises a ventral belt unit through which at least some of said sense signals are directed to said transmitter in said handle,
sense signals generated in the handle opposite the handle having said transmitter are conveyed to said transmitter to the elbow sensors and the ventral belt unit,

The invention further proposes a video game input device for use with a standard video game equipment capable of displaying varying representations of a human body, said device comprising sensors for transforming movements of a user into sense signals, and a processing unit for converting said sense signals into standard control signals for said video game equipment, wherein each sensor comprises a case for attachment to the human body, a hull movably connected to said case and a micro-switch responsive to the movements of said hull.

Preferred aspects this video game input device are the following:
said hull is movable in response to a pressure generated thereon upon bending a joint of the human body,
said case and said hull jointly define an internal space in which said micro-switch is mounted,
the hull has substantially a half-ellipsoidal shape,
each case comprises a pair of opposed eyelets for attachment of an elbow or knee strap.

The invention further proposes a video game input device for use with a standard video game equipment capable of displaying varying representations of a human body, said device comprising sensors for transforming movements of a user into sense signals, and a processing unit for converting said sense signals into standard control signals for said video game equipment, wherein each sensor comprises a case for attachment to an elbow region of the human body by means of a strap, wherein a buckle is attached to one end of the strap and said strap comprises a retaining element which prevents the strap from leaving the aperture of said buckle, whereby said sensor can be positioned on the elbow with one hand only.

The invention further proposes a combination of an input device according to any of the preceding claims and a standard video game equipment, said device being connected to a sandard gamepad connector of said equipment.

Other objects, characteristics, and advantages of the invention will appear on reading the following detailed description given with reference to the accompanying figures, in which:

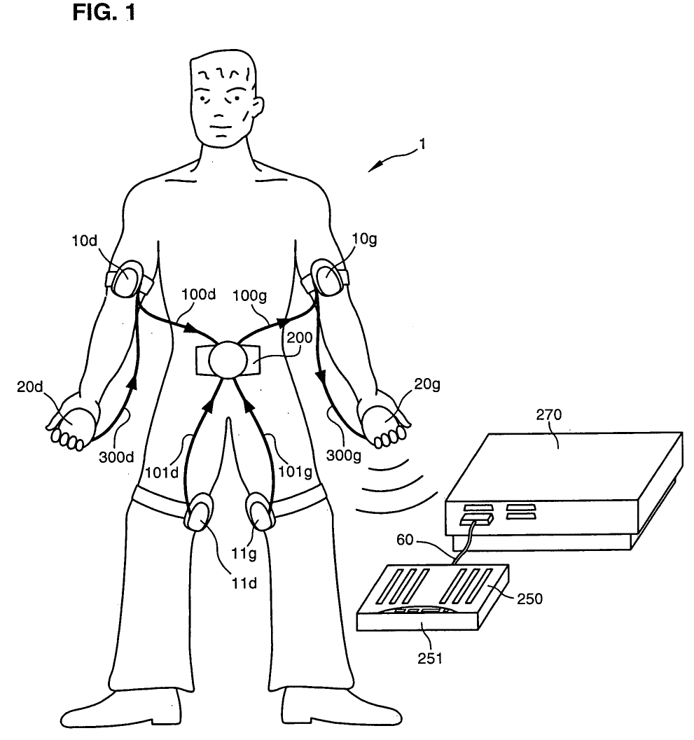

FIG. 1 is a diagram of a combination of the invention, the apparatus being set on the user,

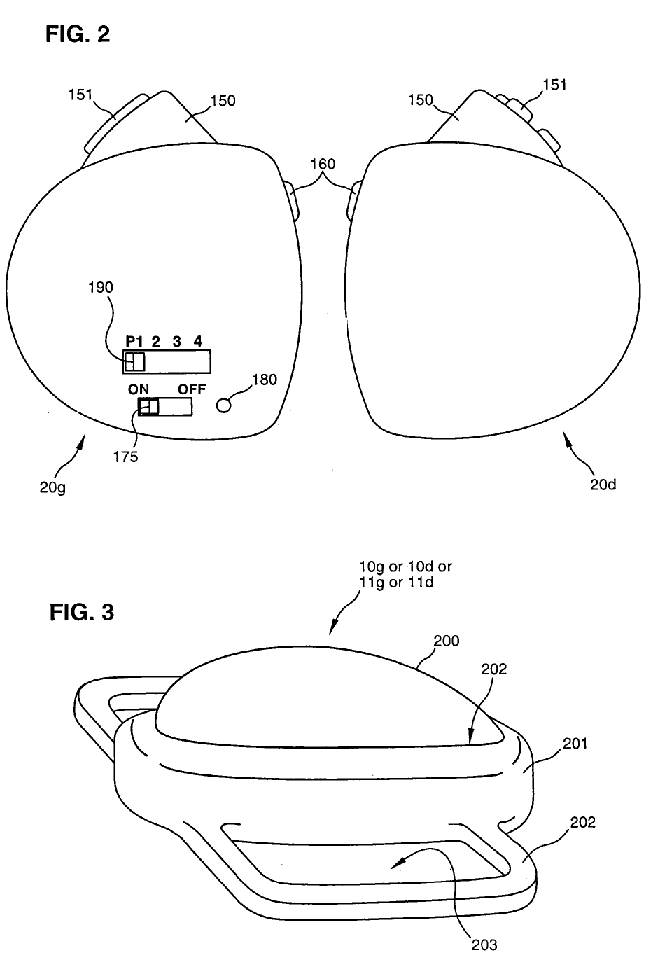

FIG. 2 is a side view of the left and right handles included in the apparatus of the invention,

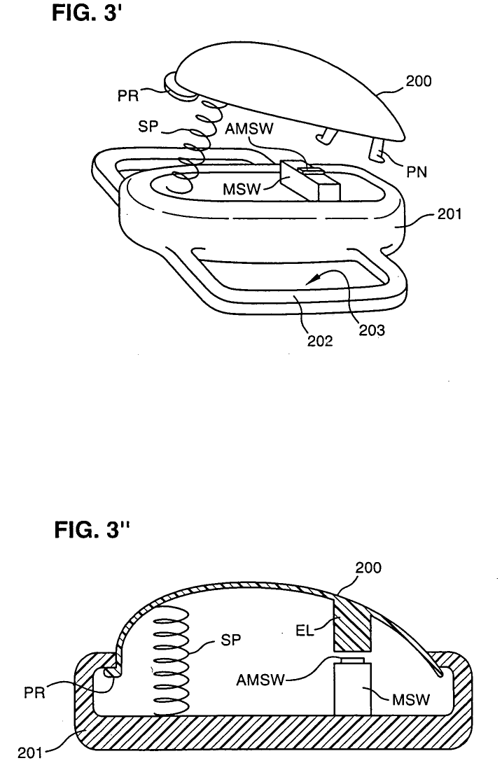

FIG. 3 is a perspective view of a sensor included in the apparatus of the invention,

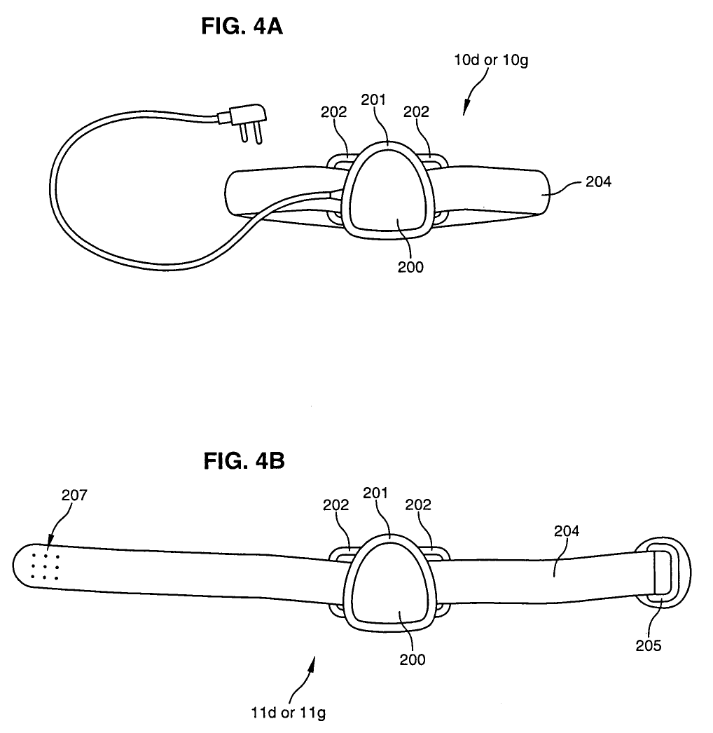

FIG. 4 shows a plan view of a the leg and arm sensors included in the apparatus of the invention,

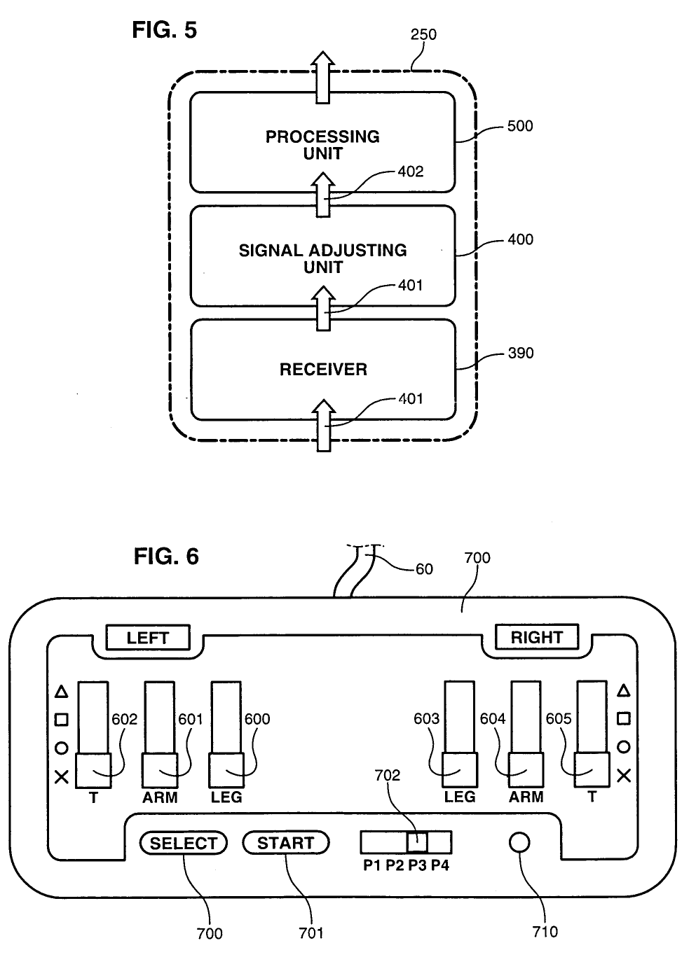

FIG. 5 illustrates a functional arrangement of a processing unit module according to the invention,

FIG. 6 is a plan view of a processing unit box according to the invention,

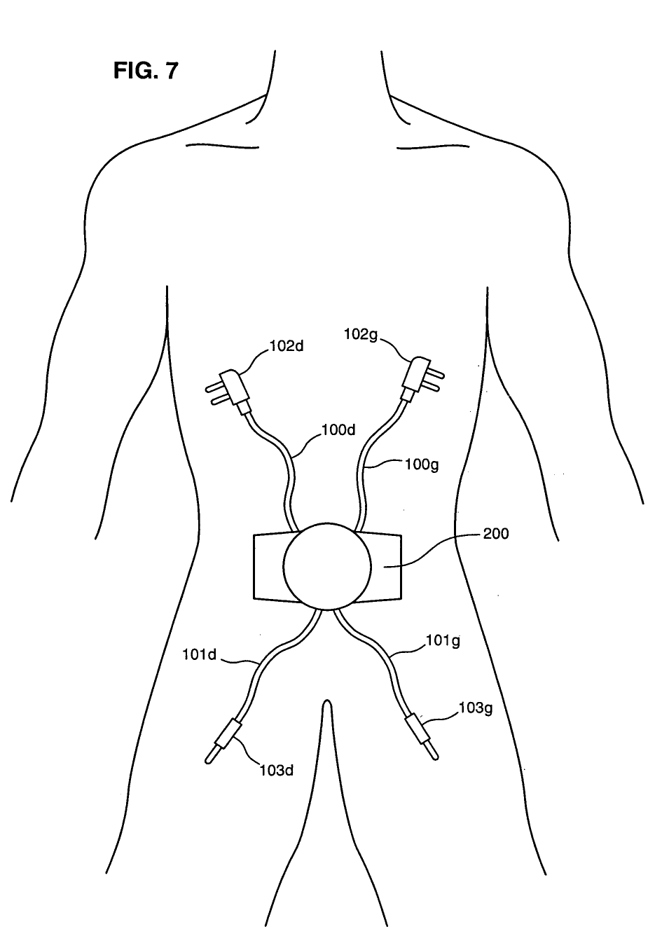

FIG. 7 illustrates connectors used in the apparatus.

Preliminarily, in this application it is understood that a standard video game equipment may consists in a video game equipment sold in the general public market.

In particular, it may consist in a standard game console or a personal computer.

As a non limitative example, the standard game console may be a Playstation or Xbox console.

Further, a sense signal will refer to a signal generated by an apparatus and this signal may not be understandable by a standard video game equipment.

Referring to FIG. 1, a combination according to the invention is shown.

This combination comprises a video game input device and a standard video game equipment 270.

The video game input device comprises an apparatus 1 and a processing unit 250.

The apparatus 1 is of star architecture, having a center constituted by a ventral belt module 10 with four branches 100g, 100d, 101g and 101d constituted by wired connections to movement sensors 10g, 10d, 11g and 11d, respectively.

In this preferred embodiment of the invention, the movement sensors are responsive to knee bending 11g, 11d and to elbow bending 10g, 10d.

The two branches 100g and 100d extend beyond the respective sensors 10g, 10d to handles 20g, 20d.

Each of these handles is provided with a pad 150 of pushbuttons, the type of which is illustrated by reference 150 in FIG. 2.

When triggered, these pushbuttons generate a sense signal.

As a non limitative example, if the standard video game equipment is a Playstation, the pad on handle 20g comprises four pushbuttons triggering the Up, Down, Left, Right Playstation signals, and the pad on handle 20d comprises four pushbuttons triggering the L1, L2, R1, R2 Playstation signals.

As another non limitative example, if the standard video game equipment is a Xbox, the pad on handle 20g comprises four pushbuttons triggering the Up, Down, Left, Right Xbox signals, and the pad on handle 20d comprises four pushbuttons triggering the L, R, Black, White Xbox signals.

Moreover, according to the invention and as illustrated in FIG. 2, each handle comprises, preferably on their side opposite to the one facing the user's body, an additional pushbutton 160.

Such an additional pushbutton 160 makes it possible to improve the playability of the user.

In particular, he is able to carry out easily an additional action associated to this additional pushbutton 160.

In other words the additional pushbutton may deliver a further sense signal.

A further advantage of this pushbutton 160 resides in the fact that the additional action can be customized by the user.

In particular, it will be described later that the user may have a choice to customize this additional action among four preselected ones (this is a non limitative example).

As can be seen in FIG. 1, sensors 11g and 11d are placed behind the joint of the knees and preferably above this joint so that they do not slip downwards the leg.

Sensors 10g and 10d are placed at the hollow of the elbows and preferably above the joint so that they do not slip downwards the arm.

The user also wears the ventral belt module 200 on the abdomen.

As illustrated still in FIG. 1, the wire cables run along the user's arms and thighs to the sensors, with the connections between the sensors 10g, 10d and the handles 20g, 20d extending substantially along the forearms, so as to interfere as little as possible with the movements of the user.

An installation of this apparatus on the body of the user is made easier thanks notably to a differentiated marking of the sensors, the belt module and the handles.

FIG. 7 illustrates another aspect of the invention which facilitates such an installation.

As can be seen, the four cables 100g,d and 110g,d start running from the belt module 200 and end with a connector, respectively 102g,d and 103g,d.

And the connectors 102g,d supposed to be plugged to the arm sensors 10g,d are differentiated from the ones 103g,d to be plugged to the leg sensors 11g,d.

To this regard, in the non limitative example of FIG. 7, connectors 102g,d comprise two pins, whereas connectors 103g,d comprise one pin only.

Regarding the structure of the sensors, they all comprise a micro switch enclosed between an ergonomic hull 200 and a case 201 (FIG. 3).

The assembly of the case and the hull is made possible thanks to an aperture 202 in the case 201.

In particular, the aperture is conformed to intimately receive the hull 200.

The micro switch has an active part which is held away from the hull by a spring.

When a pressure higher than the spring strength is applied to the hull, the latter is displaced inside the case so as to reach an active part of the micro switch and thus delivers a ON or a OFF sense signal depending on the type of sensor considered (see later for more details).

Inversely, when the pressure is less than or equal to the spring strength, the spring pushes back the hull from the active part of the micro switch and thus a OFF or ON sense signal is delivered, respectively.

FIGS. 3′ and 3″ describes more precisely the arrangement of the hull, the spring, the case and the microswitch.

In FIG. 3′, the hull 200 is dismounted from the case 201, so as to show how the spring SP and the microswitch MSW can be placed inside the case.

This figure also shows that the hull comprises plastic pins PN and a projection PR, so as to prevent the hull leaving the case once the sensor is completely assembled.

Further, the will rotate around the plastic pins towards inside or outside the case.

FIG. 3″ shows the sensor which is assembled.

It can be seen, that the hull comprises inside the case an element EL arranged so as to press the active part AMSW of the microswitch when a sufficient force is exerted on the hull.

When a force from any direction is applied to the hull, the lateral component of this force is ineffective to move the hull because its sides are blocked inside the case, and the force downward component, because of the shape of the hull, will press the hull down and thus the element will reach the active part of the microswitch.

In order to improve the ergonomics and the efficiency of the sensors, the outside shape of the hull is substantially half of an ellipsoid.

Such a shape ensures in particular that a pressure applied to the hull has substantially the same efficiency whatever its direction.

An advantage of this resides in the fact that the sensors are efficient even when they are in an approximate position.

As an example, sensors 11g and 11d remain fully functional even if, during a game, they are displaced towards their initial position in the hollow of the knee.

Generally, sensors 10d,g and 11g,d are quite identical, however they may have specificities which will be described now.

In sensors 11g and 11d, a ON sense signal is delivered when a pressure higher than the spring strength is applied to the hull so that the latter reaches the active part of the micro switch.

As an example, a sense signal ON is delivered when the player flexes the leg to prepare a kick.

Inversely, a sense signal OFF is delivered when the pressure is lower than the spring strength so that the hull looses contact with the active part of the micro switch.

In sensors 10g and 10d, the micro switches deliver a sense signal ON when their active part is not pressed by the hull, and inversely.

Thus, when the user is in a boxing guard position, a pressure is exerted on the hull of sensors 10g and 10d.

And each hull, pressing the active part of the respective micro switches, delivers a sense signal OFF.

Now, when the user gives a punch and thus extends one arm, he ceases exerting the pressure on the associated hull.

Consequently, the spring pushes back this hull from the active part of the micro switch and a sense signal ON is delivered.

Another difference concerns the top shape of the hull.

If, in sensors 11g and 11d, this shape is generally satisfying the one in sensors 10d and 10g makes it possible to offer an even more comfort.

To that effect, the shape is a little bit more flat in sensors 10d and 10g.

Such an improvement in terms of comfort is very important considering that the user may typically keep his arms flexed during a long time against sensors 10d and 10g.

Another advantage of such a shape is that the hull can be released quicker when the arm is extended and typically gives a punch.

On another end, the rounder shape of the hull of sensors 11g and 11d makes it possible to press quicker the hull with the leg, because the bending course of this leg is slightly reduced.

Hence, the user can carry out a virtual kick with little effort.

Another difference concerns the attaching straps.

As shown in particular in FIG. 4B, sensors 10d and 10g comprise two opposite sides of the case 201 having an extended projection 202 provided with an eyelet 203.

The eyelet 203 is conformed so as to receive a strap 204, preferably elastic, having two extremities.

A buckle 205 is fixed at one of the extremities.

And in order to fasten the sensor around the leg, the other extremity, herein referred as a free extremity, is first inserted in an eyelet of the buckle and then tied firmly by the user.

Further, in order to keep the strap 204 tied, well-known means may be used such as velcro 207 or snap-fasteners.

Now, in sensors 10g and 10d, once the free extremity of the strap 204 is engaged enough in the buckle, it can no more be disengaged from said buckle.

Indeed, a retained element is arranged on the surface of the strap so as to interfere with the buckle before said strap may be about to leave said buckle.

More precisely, the retained element may abut against the buckle when, running backwards, the free extremity of the strap may be about to enter the eyelet of the buckle.

An advantage of such an arrangement resides in the fact that the user is able to install sensors 10g and 10d with one hand only.

It is to be noted that said retaining element may be able to pass through the aperture of the buckle if the user applies a sufficient strength.

Such an operation is typically useful if, for example, the sensor has to be dismounted.

When sensors 10g, 10d, 11g, 11d or the pushbuttons of the handles 20d, 20g are activated, signed sense signals are transmitted from these elements to one predetermined handle 20g or 20d, the handle in question comprising advantageously a wireless communication module.

For example, in the case where this wireless module is installed in the left handle 20g as shown in FIG. 1, all the sense signals which are generated by the sensors are conveyed to this handle through at least the wire cable 300g.

In particular, as indicated by arrows in FIG. 1, a sense signal generated in the right handle 20d is conveyed to the left handle 20g along the following connection:
cable 300d-sensor 10d-cable 100d-belt module 200-cable 100g-sensor 10g-cable 300g-handle 20g.

Moreover, as can be seen in FIG. 1, the sense signals of the leg sensors 11g, 11d are conveyed by the cables 101g, 101d to the belt module 200 and then to the left handle 20g through the arm sensor 10g.

All of these sense signals are conveyed to the wireless communication module included in the handle 20g.

Then, said radio communication module transmits these signals, without no modification or few, to the processing unit module 250 which is connected to the standard video game equipment 270.

It is to be noted here that the connection between the processing unit 250 and the standard video game equipment 270 is ensured with a wiring cable 60 having, at an extremity, a standard connector supposed to be plugged in a standard game pad connector of the standard video game equipment 270, preferably a port usually used to connect a traditional joystick or game control.

One of the main functions of the processing unit 250 consists in converting the sense signal delivered by the radio communication module of handle 20g into signals understandable by the standard video game equipment 270, herein referred as control signals or standard control signals.

To this end, FIG. 5 shows that the processing unit 250 comprises a radio communication module 390, but also a signal adjusting unit 400 and a formatting unit 500.

As illustrated in this figure, the sense signals 401 received by the radio communication module 390 are successively processed by the signal adjusting unit 400 and the formatting unit 500.

Given an identified sense signal 401, for example an ON/OFF signal generated by the left arm sensor 10g, the signal adjusting unit 400 provides the formatting unit 500 with a corresponding intermediate control signal 402 which the computer or the console may understand after a light formatting step.

Typically, the intermediate control signal 402 corresponds to one among the well-known signals used in a standard video game equipment such as a signal “Square”, “Triangle”, “Cross” or “Round” in the case of a Playstation or signal “A”, “B”, “X”, “Y” in the case of a Xbox.

The above-mentioned light formatting step, which is performed by the formatting unit 500, makes it possible to condition the intermediate control signal 402 so that it can be transmitted to the standard video game equipment 270.

Therefore, a control signal notably corresponds to an intermediate control signal conditioned to be transmitted according to the communication protocol.

Further, the above-mentioned operation consisting in converting the sense signals 401 and which is performed by the signal adjusting unit 400 is achieved according to a predetermined configuration of conversion defined by the user.

To this regard, FIG. 6 shows a top view of a processing unit box 700 comprising the processing unit 250.

As can be seen in this figure, the top side of this processing unit box 700 comprises six manual actuators 600-605 movable by the user in a longitudinal aperture according to four different positions corresponding to the four well-known control signals for the standard video game equipment 270 (for example, “Cross”, “Round”, “Square”, “Triangle” for a Playstation).

Four of the six manual actuators correspond to the four sensors placed on the body of the user, respectively.

As a non limitative example, manual actuators 600 and 601 are assigned to sensors 11g and 10g and manual actuators 603 and 604 are assigned to the sensors 11d and 10d.

The two additional manual actuators 602 and 605 are assigned each to said additional pushbutton 160 mounted on each handle.

Thus, provision of the six manual actuators makes it possible to assign, in an independent way, an action, or analogously a sense signal generated by a triggered sensor, or a handle's additional pushbutton, to a particular control signal for said standard video game equipment 270.

As a non limitative example, when the manual actuator 601 is set to the position “Square”, any sense signal generated by the sensor 10g, namely the sensor of the left arm, and received by the radio communication module 390 of the processing unit, is converted into an intermediate control signal “Square” 402 at the output of the signal adjusting unit 400.

Then, as mentioned previously, this intermediate control signal “Square” 402 is conditioned into a control signal by the formatting unit 500 so as to be finally transferred, via the connecting cable 60 and using the communication protocol, to the standard video game equipment 270.

Thus, an advantage of the video game input device of the invention resides in the fact that the user can play with different games with realism.

The top side of the processing unit box shown in FIG. 6 also comprises two pushbuttons 700, 701 and an additional manual actuator 702.

When one of these pushbuttons is pressed, the user can navigate in the game menu.

As an example pressing one these pushbuttons enables to activate the “select” and “back” functions in the case of a Playstation or Xbox console game, respectively.

Therefore, as can be understood, arranging these traditional pushbuttons at the level of the processing unit box 700, and not at on the pad 150 of one of the handles, offers a real ergonomic advantage.

In particular, the complexity of the pad 150 is reduced so that handling is improved, notably during a play.

Concerning the above-mentioned manual actuator 702, it can be moved along an aperture according to different fixed positions.

As will be seen later, each position corresponds to a particular radio frequency channel which can be used to communicate with the handle 20g, thus enabling a multi-user play.

In a first aspect of the invention, the communication is a 2.4 GHz one way radio communication.

Thus, the handle comprises a transmitter and the processing unit module a receiver.

In a second aspect of the invention, which is the preferred one, a 2.4 GHz bidirectional radio communication is used.

An advantage of this bidirectional radio communication resides in the fact that the user can receive a feedback of the various actions he is carrying out during the game.

To that effect, the processing unit module 205 transmits wirelessly feedback signals to the handle 20g containing the radio communication module.

It is to be noted that the feedback signals may be provided by the standard video game equipment.

Then, the handle 20g receiving the feedback signals transmits them to the corresponding sensors placed on the body of the user.

Concerning the power supply of the radio communication module in the handle 20g, batteries are preferably installed in the handle itself.

An ON/OFF button, such as a manual actuator 175 illustrated in FIG. 2, activates the provision of power to this communication module and a light indicator, such as a LED 180 (Light Emission Diode), placed on the left handle 20g, indicates such activation.

A power supply is also provided to the communication module of the processing unit 250.

In the preferred embodiment of the invention, it corresponds to the power supply of the standard video game equipment and it is provided via the wiring cable 60.

A dedicated power supply could be used as an alternative.

The processing unit box 700 also comprises a LED 710 which light continuously on indicates a good radio frequency transmission.

On the contrary, flicker of this light indicates an incorrect radio frequency transmission.

In order to enable a multi-user play, the wireless connection is a multi-frequencies connection.

To this end, the processing unit box 700 is already provided with a multi-switch button, such as the manual actuator 702 of FIG. 6, which makes it possible to select one of the available radio frequency channels.

In particular, in the example illustrated in FIG. 6, there are four radio frequency channels available, each of them being possibly assigned to four different users.

In this manner, each player, who owns a processing unit box 700 and an apparatus 1 according to the invention, is identified with respect to its personal radio frequency channel.

Naturally, a similar multi-switch button 190 is provided at the handle 20g having the radio communication module.

This multi-switch button 190 may be positioned so that the selected radio frequency channel of the user in question corresponds to the one selected in the processing unit box 700.

It is understood that many other alterations, modifications, and improvements of the invention are intended to be part of this disclosure, and are intended to be within the scope of the present invention.

In particular, the person skilled in the art will be able to modify the straps of the sensor.

As an example, it is possible to use a simple closed band with elastic properties.

Further, the radio communication module may utilize another frequency than 2.4 Ghz.

And more generally, another technology could be used for the wireless communication modules (infra red, etc).

Concerning the possibility to configure the sense signal conversion with the signal adjusting unit, it is also possible that part of this configuration be performed automatically.

As an example, the processing unit can be arranged in such a manner that it recognizes the standard video game equipment.

Then, a default configuration can be determined and applied to the signal adjusting unit accordingly.

Naturally, a possibility may be offered to accept, refuse or modify this default configuration.

1. A video game input device for use with a standard video game equipment capable of displaying varying representations of a human body, said device comprising an apparatus for transforming movements of a user into sense signals and a processing unit for converting the sense signals into standard control signals for said standard video game equipment, said processing unit comprising an adjusting unit allowing the user to configure the conversion of said sense signals into said control signals.

2. A device according to claim 1, wherein the adjusting unit comprises manual actuators which the user can move according to predefined positions, each position corresponding to a predefined conversion of a sense signal into a control signal.

3. A device according to claim 2 wherein each actuator has, at the maximum, as many predefined positions as the number of possible control signals for said video game equipment.

4. A device according to claim 1, wherein said processing unit is connectable by a cable to a standard gamepad connector of a video game equipment.

5. A device according to claim 1, wherein said cable comprises a power line through which said processing unit can draw power from said video game equipment.

6. A video game input device for use with a standard video game equipment capable of displaying varying representations of a human body, said device comprising a first part to be worn by a user for transforming movements of a user into sense signals, and a second part having a processing unit for outputting to said video game equipment standard control signals generated from said sense signals, and a wireless communications channel between said first part and said second part.

7. A device according to claim 6, wherein said first part is powered by at least one battery.

8. A device according to claim 6, wherein the wireless communications channel is selected among available predefined communication channels, enabling in particular a multi user game.

9. A device according to claim 8, wherein the first and second parts of the device comprise a wireless communication module using a wireless communication channel selected among the predefined available communication channels, this selection being set by the user which can move an actuator in the first part and the second part, according to different positions corresponding to the available predefined communication channels.

10. A device according to claim 6, wherein said first part comprises:
a pair of elbow sensors adapted to be positioned in respective elbow regions of the user to deliver two different sense signals depending on elbow bend, and
a pair of knee sensors adapted to be positioned in respective knee regions of the user to deliver two different sense signals depending on knee bend.

11. A device according to claim 10, wherein said first part further comprises a pair of handles connected by respective wires to the pair of elbow sensors, each handle comprising at least one button capable of generating a further sense signal.

12. A device according to claim 11, wherein said wireless communication's channel is established between a transmitter in one of said handles and said second part.

13. A device according to claim 12 wherein said first part further comprises a ventral belt unit through which at least some of said sense signals are directed to said transmitter in said handle.

14. A device according to claim 13, wherein sense signals generated in the handle opposite the handle having said transmitter are conveyed to said transmitter to the elbow sensors and the ventral belt unit.

15. A video game input device for use with a standard video game equipment capable of displaying varying representations of a human body, said device comprising sensors for transforming movements of a user into sense signals, and a processing unit for converting said sense signals into standard control signals for said video game equipment, wherein each sensor comprises a case for attachment to the human body, a hull movably connected to • said case and a micro-switch responsive to the movements of said hull.

16. A device according to claim 15, wherein said hull is movable in response to a pressure generated thereon upon bending a joint of the human body.

17. A device according to claim 16, wherein said case and said hull jointly define an internal space in which said micro-switch is mounted.

18. A device according to claim 15, wherein the hull has substantially a half-ellipsoidal shape.

19. A device according to claim 15, wherein each case comprises a pair of opposed eyelets for attachment of an elbow or knee strap.

20. A video game input device for use with a standard video game equipment capable of displaying varying representations of a human body, said device comprising sensors for transforming movements of a user into sense signals, and a processing unit for converting said sense signals into standard control signals for said video game equipment, wherein each sensor comprises a case for attachment to an elbow region of the human body by means of a strap, wherein a buckle is attached to one end of the strap and said strap comprises a retaining element which prevents the strap from leaving the aperture of said buckle, whereby said sensor can be positioned on the elbow with one hand only.

21. A combination of an input device according to claim 1 and a standard video game equipment, said device being connected to a sandard gamepad connector of said equipment.
